(19) United States
(12) Patent Application Publication
(10) Pub. No.: US 2015/0290600 A1
(43) Pub. Date: Oct. 15, 2015

(54) DEVICE AND METHOD FOR MIXING BULK MATERIAL WITH A LIQUID AND USE OF A DEVICE

(71) Applicant: BÜHLER AG, Uzwil (CH)

(72) Inventors: Heinz LAUERMANN, Sitterdorf (CH); Madlen HASLER, Winterthur (CH); Patrice BERNARD, Linden (CH); Fabian ARNOLD, Mund (CH); Marius ALLENSPACH, Flums (CH); Andreas STÖPPLER, Trogen (CH); Andreas FRANK, St. Gallen (CH)

(21) Appl. No.: 14/440,119

(22) PCT Filed: Oct. 31, 2013
(86) PCT No.: PCT/EP2013/072830

§ 371 Date: Jul. 1, 2015

(30) Foreign Application Priority Data
Nov. 2, 2012 (EP) 12191025.1

(51) Int. Cl. B01F 5/20; A21C 1/14; C12C 7/04; B01F 3/12; B01F 15/02

(52) U.S. Cl. CPC B01F 5/205; B01F 3/1228; B01F 15/0254; B01F 15/0251; C12C 7/042; A21C 1/1435; B01F 2215/0011; B01F 2215/0068

(57) ABSTRACT

A device (1) that is suitable for continuously wetting and/or mixing bulk material with a liquid in order to produce a mixture, in particular a food mixture. The device (1) comprises a bulk material feeding apparatus for feeding the bulk material into a treatment region (9) and a liquid feeding apparatus (7) for directly applying the liquid to the bulk material in the treatment region (9), The bulk material can be fed into the treatment region (9) as a curtain (10) by the bulk material feeding apparatus, wherein the liquid can be applied to the curtain (10) substantially completely at least on the outer surface (33) by the liquid feeding apparatus (7).

The invention relates to an apparatus and a method for continuously wetting and/or mixing bulk material with a liquid, and to the use of such an apparatus according to the preambles of the independent claims. In particular, the present invention relates to an apparatus and a method for producing a dough product.

Traditionally, dough products and many other food mixtures too are obtained from, a bulk material and a liquid by a process in which the bulk material and the liquid are introduced separately into a container and then mixed together with the aid of a stirrer, which could be arranged in a bottom area of the container. For this purpose, however, mixing has to be carried out for a very long period in order to obtain satisfactory mixing of the ingredients.

In order to achieve better mixing in a shorter time, it has already long been proposed in the prior art to spray the bulk material in free fall with the liquid. For example, DE 602 996 discloses an apparatus for continuously mixing granular substances with liquids, in particular flour with water in order to make dough for baking purposes. A mixing container of this apparatus is surrounded by a circular water pipe on which spray nozzles distributed uniformly about the circumference sire arranged at the same height, such that, in a plan view, their main axes touch a circle lying concentrically with respect to the container axis. However, with this apparatus too, it is not possible to obtain a particularly homogeneous mixture of the ingredients.

U.S. Pat. No. 4,323,314 discloses a farther apparatus and a method for adding liquid components inter alia to bulk material. The apparatus comprises a mixing container into which the bulk material is fed by means of a conveyor. In an upper feed section for the bulk material, there is a conically widening deflector that generates a hollow cylindrical stream of bulk material. Several nozzles are arranged in a treatment zone for the purpose of wetting the tubular bulk material. However, the thickness of this tubular layer does not permit sufficient wetting of the hulk material all the way through its thickness. Consequently, it is likewise not possible to achieve particularly homogeneous mixings. Nor can this disadvantage be overcome by the central nozzle proposed in U.S. Pat. No. 4,323,314 and arranged at the upper end of the mixing container.

DE 968 781 discloses an apparatus for producing bread doughs. It comprises a chamber in which a lattice-shaped charging electrode is located for the flour falling through. A ring of nozzles for spraying and atomizing water is arranged in the lower part of the chamber. The flour is conveyed into the chamber through a funnel by means of a feeding device, for example a vibratory feeder. A cone of the electrode is mounted in a forward position in order to easily decelerate and scatter the flour. As it passes through the electrode, the flour is electrically charged. Below the electrode, the flour sweeps through the mist zone of the water and is wetted. However, on account of the rat mice-shaped electrode, this apparatus permits only a comparatively small throughput of flour. In particular, however, the electrode means that this apparatus is extremely complex to produce and also to operate. This apparatus is due to the electrode particularly

Furthermore, DE 102 19 683 C1 discloses inter alia an apparatus for making dough, with a mixing chamber and a screw conveyor for transporting ingredients into the mixing chamber. In the mixing chamber, the ingredients lie on the underside of the mixing chamber and are there exposed to liquid at a high pressure by a nozzle unit, said liquid being directed to an inner wall of a housing of the mixing chamber, such that the ingredients are mixed together to give a dough-like consistency.

This known prior art has the disadvantage that, after dough has been prepared, residues of the dough may remain adhering to the apparatus. On account of the design of the apparatus and the fact that dough residues remain attached after the dough has been prepared, an at least partial disassembly of the apparatus is necessary for cleaning, which is time-consuming and entails substantial operating costs.

If is therefore an object of the present invention to avoid the disadvantages of the prior art, in particular to make available an apparatus and a method by which, a reliable continuous wetting and/or mixing of bulk material with a liquid can be carried, out and cleaning of the apparatus can take place substantially without disassembling the apparatus. A particular aim is to obtain a mixture that is as homogeneous as possible. Moreover, an apparatus is to be made available in particular that allows cleaning to be carried, out substantially in situ without disassembly, i.e. what is known as “cleaning in place” (CIP). A further object of the present invention is in particular to make available a distribution device for a dough produce, which permits cleaning substantially without disassembly of the distribution device.

These objects are achieved, by an apparatus and a method according to the independent claims.

The apparatus according to the invention is suitable for continuously wetting and/or mixing bulk material with a liquid, in order to produce a mixture, in particular a food mixture such as a dough product. In other words, the apparatus is suitable for wetting and/or mixing bulk material with a liquid in a continuous operation with constant feeding of material and removal of material.

Here, and in the rest of the text, a food mixture is understood as a mixture that is suitable as food. Substances or products are regarded as food if they are intended to be consumed, or can reasonably be expected to be consumed, in a processed, partially processed or unprocessed state by humans. Flour in particular is used as the bulk material, and water in particular is used as the liquid. It is alternatively possible, for example in brewing, for a starchy raw brewing material to be used as the bulk material. This starchy raw brewing material can contain or consist of malt, starch, rice (in particular in the form of broken rice and/or rice flour and/or rice flakes), grist (in particular barley grist), maize (in particular maize grits and/or maize flour) or any desired combinations of these. In these uses in brewing, the mixture is referred to as a mash which, within the meaning of the present invention, is likewise regarded as a food mixture.

The apparatus comprises a bulk material feeding device for feeding the bulk material into a treatment zone and a liquid feeding device for directly applying the liquid to the bulk material in the treatment zone. The bulk material can be fed in so the treatment, zone as a curtain by means of the bulk material feeding device, wherein the liquid can be applied to the curtain substantially completely, at least on the outer surface of the curtain, by means of the liquid feeding device.

In other words, liquid can be applied at least to an envelope surface of the curtain in the treatment zone.

This has the advantage that better wetting and/or mixing of the bulk material with the liquid can take place even at liquid pressures lower than in the prior art, as a result of which the apparatus has fewer deposits during its operation. By virtue of the fewer deposits, the apparatus is therefore advantageously easier to clean.

In particular, a dough product can be a sourdough or a bread dough that is suitable for producing bakery items. For example, a rye sourdough or also a wheat pre-dough can be produced as dough product.

Within the meaning of the present, application, “directly applying” the liquid to the bulk material is understood to mean that the liquid is conveyed to the bulk material directly from the liquid feeding device, for example by spraying onto the bulk material, for example with at least one nozzle.

Within the meaning of the present application, a “treatment zone” is understood as the area of the apparatus in which the bulk material is exposed to the liquid during the intended use.

Within the meaning of the present application, feeding the bulk material as a “curtain” info the treatment zone is understood to mean a layer of the bulk material whose thickness in the treatment zone is in the range of 1 mm to 25 mm and preferably of 2 mm to 17 mm. Thicknesses in this range ensure a compromise between a sufficient throughput of bulk material and a sufficient wetting of the bulk material through the entire thickness or the curtain. By contrast, for example, the electrode of DE 968 781 already mentioned above instead causes an atomization of the flour, and therefore no curtain, within the meaning of the present invention arises at all. In particular, the thickness of the layer of bulk material in the treatment zone is smaller by at least a factor of 20, preferably at least a factor of 50, and particularly preferably at least a factor of 150, than a width of the layer in the treatment zone; the width of the layer in the treatment zone is defined substantially perpendicularly with respect to the bulk material conveying direction and perpendicularly with respect to the thickness; the length of the curtain in the treatment zone is defined substantially parallel to the bulk material conveying direction.

Within the meaning of the present application, the term “bulk material” is understood as a granular, floury or also lumpy material that is present in a pourable form and in particular is free-flowing. In particular, bulk material, is understood as meaning rice flour, flour, grist, baking mixtures, corn, free-flowing powdery substances, and any desired combinations thereof.

According to the invention, the bulk material feeding device is designed as a device for uniform feeding of the bulk material into the treatment zone. This uniform feeding of the bulk material permits a homogeneous mixing of the bulk material with the liquid, in particular to give homogeneous dough products.

For this purpose, the bulk material feeding device advantageously comprises substantially vertically arranged screw conveyor for conveying the bulk material into the treatment zone. Within the meaning of the present application, the term “substantially vertically” is understood as an angle to the vertical of at most 10°, preferably at most 2° particularly preferably at most 0°.

With the aid of a vertically arranged screw conveyor, the bulk material can be conveyed particularly uniformly and continuously into the treatment zone, such that particularly homogeneous dough products can be obtained in particular. By contrast, with a horizontally arranged screw conveyor, such as is shown in DE 602 996 for example, the bulk material is conveyed into the treatment zone in individual portions according to the speed of rotation of the screw.

Particularly preferably, a diameter of a screw of the screw conveyor on the side facing toward the treatment zone is smaller than a diameter on the side facing away from the treatment zone. In particular, the area of decreasing diameter extends over at least two screw flights. The area of decreasing diameter is preferably arranged on the side of the screw facing toward the treatment zone. In a further area, in particular on the side of the screw facing away from the treatment zone, the diameter of the screw cam be constant. In the area of decreasing diameter, the screw can in particular have a conical design. In the area of decreasing diameter of the screw, an internal diameter of a housing of the screw conveyor, in which the screw is received, decreases less than the diameter of the screw and preferably remains constant.

This has the advantage that, in the admission area, the bulk material begins to trickle out of the screw, since the latter is arranged substantially vertically, i.e. substantially parallel so the action of the force of gravity, as a result of which the bulk material is conveyed in the shape of a curtain info the treatment chamber.

A distributor is preferably arranged between the bulk material feeding device, in particular the screw of the screw conveyor, and the treatment zone, said distributor widening, in particular conically, in the direction of the treatment zone. In particular, the widening distributor is arranged on the screw of the screw conveyor downstream from the screw flights and rotates with the screw. Alternatively, it is possible to use a separate arrangement of the widening distributor, which does not rotate with the screw.

This has the advantage that the curtain-like formation of the bulk material in the treatment zone can be better ash is sod with respect to the thickness of the curtain.

During the operation of the apparatus, the screw of the screw conveyor can rotate at a speed of rotation in the range of 500 rpm to 1500 rpm. Rotational speeds of this kind permit a particularly uniform delivery of the bulk material into the treatment zone.

Preferably, the liquid feeding device comprises at least two nozzles for directly applying the liquid to the bulk material in the treatment zone. Preferably, the liquid feeding device comprises at least six nozzles, more preferably at least sixteen nozzles and, very particularly preferably, precisely sixteen nozzles. In particular, the at least two nozzles and preferably six nozzles are designed as nozzles of the same type, which are preferably arranged on a ring and are at substantially equal distances from one another in the circumferential direction of the ring. Alternatively, the use of different nozzles is also conceivable.

This has the advantage that the wetting of the curtain can take place more reliably, for example by the selection of different nozzles and/or by the arrangement of the nozzles in the apparatus.

Preferably, the bulk material feeding device and the liquid feeding device are arranged in relation to each other in such a way that the liquid can be applied to the bulk material in the treatment zone substantially without contact with an inner wall of the apparatus. In other words, the bulk material in the treatment zone is at a distance from the inner wall in particular of a treatment chamber.

This has the advantage that undesired deposits in the apparatus during operation are further reduced, with the result that cleaning is made even easier. In particular, it is possible to do without expensive strippers as in DE 602 996.

By means of the the liquid feeding device, the liquid can preferably be sprayed onto the bulk material with a pressure in the range of 2 bar to 28 bar, preferably of 12 bar co 23 bar, and particularly preferably of 15 bar to 20 bar.

This has the advantage that, at the lower pressures compared so the prior art, the wetting and/or mixing is better controlled, with the result that undesired deposits in fine treatment chamber are further reduced.

Preferably, the at least two nozzles are arranged in such a way that the liquid is conveyed and directed to the curtain in the direction of the bulk material conveying direction. Particularly preferably, the liquid is conveyed and directed to the curtain in a direction that is at an angle in the range of 30° to 70°, more preferably in the range of 30° to 50°, with respect to the bulk material feeding direction.

This has the advantage that the liquid is directed away from the area upstream of the treatment zone, such that there is less chance of the liquid being sprayed into the area upstream of the treatment zone, and this further facilitates the cleaning of the apparatus. A situation is thus largely avoided in which, when using flour, which is usually delivered dry, dough cannot deposit or become attached upstream after the exposure to the liquid. This could block the apparatus or could also deposit dough in areas that may be difficult to clean, with the possibility of the apparatus having to be at least partially disassembled.

Preferably, the at least two nozzles in the treatment chamber are arranged spaced apart from each other in the circumferential direction. In particular, the nozzles are arranged in a ring shape. In other words, the nozzles are in particular arranged on a ring and spaced apart from each other in the circumferential direction. Two of the at least two nozzles are preferably arranged lying opposite each other in the circumferential direction.

This has the advantage of good wetting and/or mixing of the bulk material with the liquid. Particularly with an arrangement of two nozzles lying opposite each other in the circumferential direction, wherein the nozzles are oriented substantially toward the same area of the treatment chamber through which the bulk material is conveyed, it is possible to achieve still better wetting and/or mixing of the bulk material by means of the liquid. Thus, good mixing can be obtained with at the same time a reduction in the amount of undesired deposits in the apparatus.

In particular, the at feast two nozzles can be arranged on a nozzle ring connected releasably to the apparatus, this has the advantage that, depending on the bulk material to be treated, a nozzle ring with suitable nozzles arranged thereon can be selected and exchanged.

Preferably, the apparatus is designed, at least in the treatment zone, with a substantially tubular shape and a substantially constant diameter, wherein a longitudinal axis of the tubular area lies substantially parallel to the bulk material conveying direction.

This has the advantage that the mixture of bulk material and liquid can be conveyed efficiently out of the treatment chamber, without undesired deposits being obtained in the treatment chamber upstream of the treatment zone. Moreover, the treatment chamber and the components of the apparatus arranged downstream of the treatment chamber can be easily cleaned by means of the nozzles without the apparatus being disassembled. In particular, cleaning in place (CIP) is thus permitted. This can be done, for example, by feeding a cleaning liquid into the treatment zone by means of the nozzles and in particular the ring of nozzles. As an alternative to this, one or more additional CIP nozzles (not shown in the drawings) could be present or could be introduced.

An air discharge device is preferably arranged downstream of the liquid feeding device. In particular, the air discharge device is arranged between the at least two nozzles and a downstream conveying device and/or receiving device for the mixture, in particular the dough product.

the air discharge device can be designed as at least one opening to the environment of the apparatus, for example at least one hole or slit. Alternatively or in addition, the air discharge device can be designed as at least one valve, for example a ventilating valve.

This has the advantage that, by means of the air discharge device, air that is entrained by the liquid at the corresponding pressure can be reliably removed. Without the air discharge device, it is possible that the air is not reliably removed from the treatment chamber, as a result of which the mixture of bulk material and liquid can in some circumstances be conveyed upstream of the treatment zone, which can lead to undesired deposits in the apparatus.

The air discharge device is preferably arranged upstream of the liquid feeding device. This has the advantage that the occurrence of an underpressure upstream of the liquid feeding device can be substantially avoided; the occurrence of an underpressure can have the disadvantage that the feeding of the bulk material into the treatment chamber is reduced or the formation of the curtain is negatively affected, which can be substantially avoided by the arrangement of the air discharge device.

The air discharge device can be designed as at least one opening to the environment of the apparatus, for example at least one hole or slit. Alternatively or in addition, the air discharge device can be designed as at least one valve, for example a ventilating valve.

Preferably, the treatment chamber has an inlet for the bulk material and an outlet for the mixture, in particular the dough product. The at least two nozzles are arranged in an area of the treatment chamber facing toward the inlet, in particular in the upper third and preferably in the upper quarter with respect to the length of the treatment chamber substantially parallel to the bulk material conveying direction.

This has the advantage that, by arranging the at least two nozzles in an area facing toward the inlet, a greater inclination of the liquid in the direction of the bulk material conveying direction can be chosen than in the case of an arrangement in an area facing toward the outlet, as a result of which the chance of undesired deposits occurring in the apparatus is further reduced. Moreover, with a suitable orientation of the at least two nozzles, good cleaning of she inner wall is possible.

Preferably, the at least two nozzles are oriented substantially toward the treatment zone axis arranged substantially parallel to the bulk material conveying direction.

This has the advantage that the wetting and/or mixing of the bulk material by means of the liquid can be carried out at a distance as great as possible from, the inner wall of the treatment chamber, which further reduces the occurrence of undesired deposits.

The liquid feeding device preferably comprises a conditioning device for adjusting the temperature of the liquid and/or for metering at least one additional substance into the liquid. With the aid of the conditioning device, the liquid can be set to a temperature that a person skilled in the art can choose depending on the desired use. In the case of dough products, the liquid is preferably set to a temperature of less than 30° C., preferably of less than 29° C., by the conditioning device. By contrast, when used in brewing, as is described in more detail below, temperatures in the range of 30° C. to 70° C. are preferred.

This has the advantage that the liquid can be conditioned according to the product that is to be produced, so as to achieve the best possible product quality.

Downstream, the apparatus preferably has a conveying device, in particular a conveying nozzle, for conveying an auxiliary liquid, in particular yeast, onto and/or into the mixture, in particular the dough product. This has the advantage that optimal conditions for the conveying of the auxiliary liquid onto and/or into the mixture can be selected.

By means of the bulb material feeding device, the bulk material can preferably be fed into the treatment zone as a curtain shaped as a circle or as a segment of a circle. The curtain can preferably be fed as a tube. A ring segment is considered here as an angle section of a ring in the circumferential direction.

This has the advantage that the throughput of bulk material through the treatment chamber is increased, while maintaining good, wettability and/or miscibility by a suitable circular arrangement, of the nozzles.

When the bulk material is fed as a curtain having the shape of a circle or a segment of a circle, the circumference length along the circle or the circle segment is considered as the width of the curtain.

A further aspect of the present invention relates to a method for continuously wetting and/or mixing bulk material with a liquid in an apparatus. In particular, an apparatus of the kind described above is used. The apparatus comprises a treatment zone, a bulk material feeding device for feeding bulk material into the treatment zone, and a liquid feeding device for directly applying the Liquid to the bulk material in the treatment zone, The method comprises the steps of feeding the bulk material into the treatment zone as a curtain and then applying the liquid to the curtain substantially completely at least on the outer surface in order to produce a mixture and. in particular a food mixture such as a dough product.

Advantageously, the liquid is applied to the bulk material in the treatment zone substantially without contact with an inner wall of the apparatus. In this way, it is possible to do without expensive strippers as in DE 602 996, as has already been explained above.

Moreover, the apparatus can nave a distribution device for distributing the mixture, in particular the food mixture, for example a dough product for bakery purposes. The mixture, in particular the dough product, is produced in particular by a method as described above. The distribution device comprises at least one and in particular at least two maturing containers, and a circulating device is arranged in the at least one maturing container for the purpose of circulating the dough product, in particular for circulating the dough product inside the maturing container. The circulating device can be a stirrer, for example.

The distribution device can further comprise a pump device and a pipe system for distributing the mixture, in particular the dough product, into the at least one maturing container. The pipe system can be in fluidic communication with a bottom of the as least one maturing container for conveying the mixture, in particular the dough product, into the maturing container.

The conveying of the mixture, in particular of the dough product, into the maturing container through a bottom of the maturing container has the advantage that the occurrence of undesired deposits in the maturing container is minimized. In particular, deposits are minimized on and/or in the circulating device, which circulates the mixture, in particular the dough product, advantageously already during the introduction thereof into the maturing container, which, in the case of the mixture being conveyed, through a top of the maturing container, would lead to considerable deposits on and/or in the circulating device.

The pump device is in particular designed in such a way that it can be cleaned substantially without disassembly. Pumps of this kind are known to a person skilled in the art.

Dough products, in particular sourdoughs, often have relatively high viscosities. If the apparatus is intended to be used for the production of dough products, the calculating device, the pump device and the pipe system should be designed accordingly. In particular, they should meet customary hygiene standards that, apply to the production of dough products.

The distribution device preferably comprises at least two maturing containers and at least one fixture, by means of which it is possible to control and/or regulate into which of the maturing containers the mixture, in particular the dough product, is to be conveyed. In particular, the distribution device comprises at least one slider or at least one valve or any desired combinations of these, by means of which it is possible to control and/or regulate into which of the maturing containers the mixture, in particular the dough product, is conveyed.

This has the advantage that, according to the requirements or also the degree of filling of a maturing container, the fixture can be controlled and/or regulated for the appropriate filling of the maturing container.

Within the meaning of the application, a fixture is a structural element which is arranged in a pipe for the purpose of controlling and/or regulating flows of substance through the pipe.

The maturing container can have at least one opening through which the mixture, in particular the dough product, can flow into and/or out of the maturing container, wherein the maturing container can moreover contain at least one valve by means of which it is possible to control the inward and/or outward flow, With the valve closed, the mixture, in particular the dough product, inside the maturing container can be circulated with the aid of a circulating device.

During the operation of the apparatus, the mixture, in particular a dough product such as a sourdough, can be fermented, in particular during a fermentation time in the range of 3 hours to 24 hours. The fermentation is preferably carried out in a maturing container as described above. At least during most of the fermentation time, in particular during the whole of the fermentation time, it is possible to ensure that no mixture flows into the maturing container or flows out of same, for example with the aid of a valve as described above.

At further aspect of the invention concerns the use of an apparatus of the kind described above in brewing, in particular for continuously wetting and/or mixing a starchy raw brewing material (in particular one or more raw brewing materials as described above) with water. In these uses, the mixture is referred to as a mash. The latter can be mashed for example during a mash time of up to 4 hours. The mashing is preferably carried out in a maturing container (mash vessel) as described above. At least during most, of the mashing time, in particular during the whole of the mashing time, it is possible to ensure that no mixture flows into the maturing container or flows out of same, for example with the aid of a valve as described above.

In the uses in brewing, in some cases the bulk material feeding device does not necessarily have to be designed as a device for uniform feeding of the bulk material into the treatment zone, in particular not as a substantially vertically arranged screw conveyor. In particular, such a design can be dispensed with if the starchy raw brewing material has relatively coarse grains, such as is the case with grist, broken rice, rice flakes and maize grits.

For a better understanding of the invention, further features and advantages thereof are explained in more detail below on the basis of illustrative embodiments, without the invention being limited to said illustrative embodiments. In the drawing:

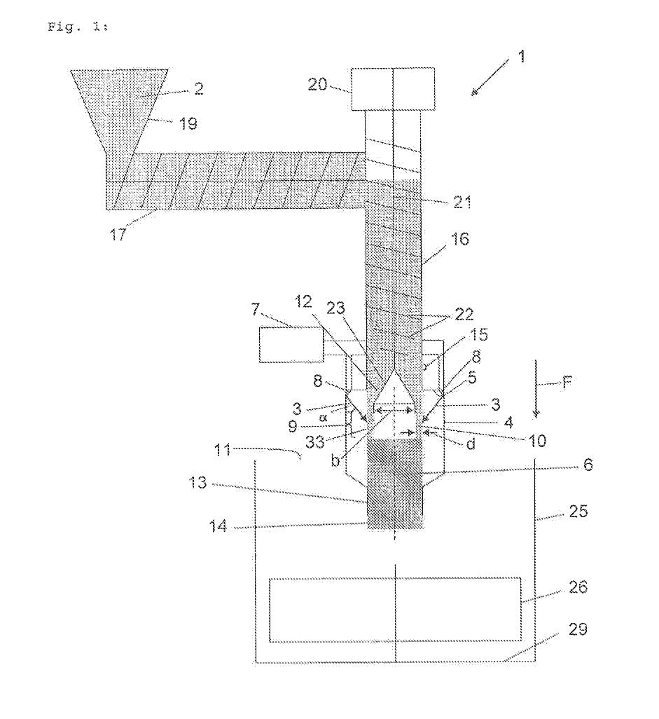

FIG. 1 shows a schematic view of an apparatus according to the invention for continuously mixing flour, with a vertically arranged screw conveyor;

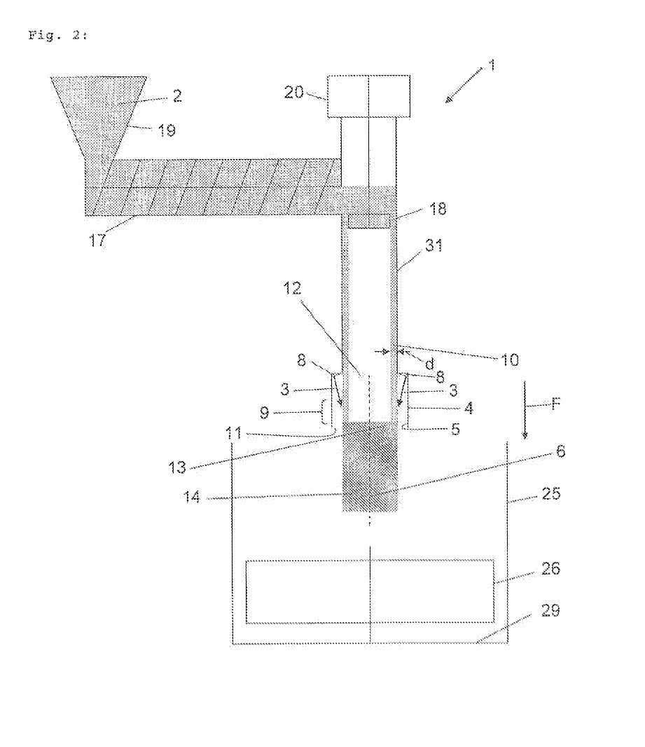

FIG. 2 shows a schematic view of an alternative apparatus according to the invention for continuously mixing flour, with a propeller;

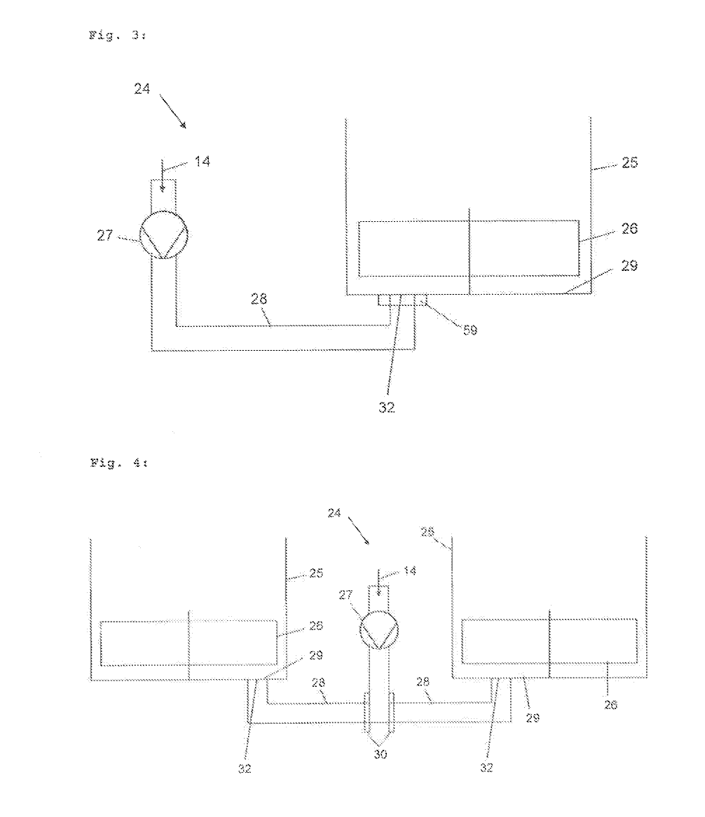

FIG. 3 shows a schematic view of a distribution device for distributing a dough product, with a maturing container;

FIG. 4 snows a schematic view of an alternative distribution device for distributing a dough product, with two maturing containers;

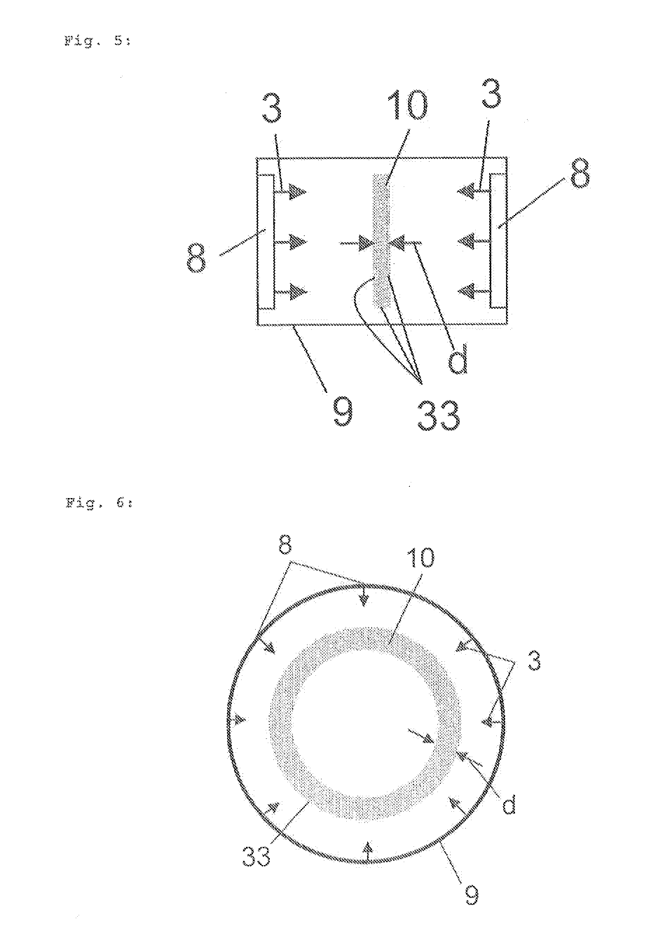

FIG. 5 shows a schematic plan view of an apparatus according to the invention with a straight curtain;

FIG. 6 shows a schematic plan view of an alternative apparatus according to the invention with a circular curtain;

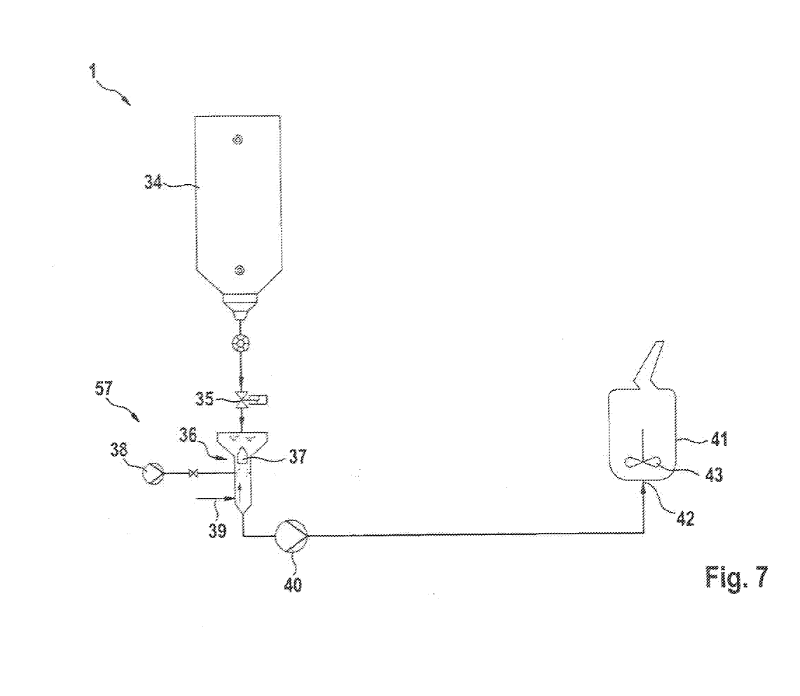

FIG. 7 shows a further apparatus according to the invention, which is suitable in particular for use in brewing;

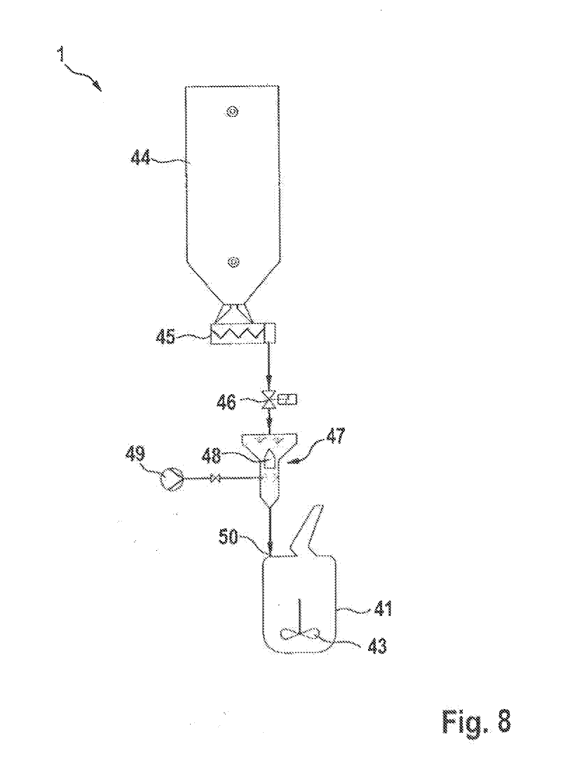

FIG. 8 shows a further apparatus according to the invention, which is suitable in particular for use in brewing;

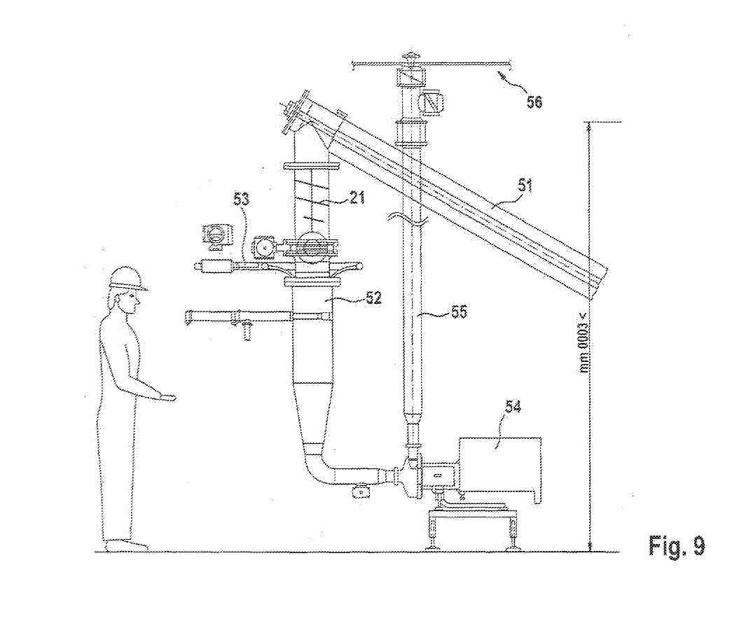

FIG. 9 shows a further apparatus according to the invention, which is suitable in particular for use in brewing.

FIG. 1 shows a schematic side view of an apparatus 1 according to the invention for continuously wetting and/or mixing flour 2 by means of water 3, wherein the apparatus comprises a vertically arranged screw conveyor 16, which constitutes a device for uniformly feeding the flour 2.

The apparatus 1 according to the invention comprises a feeding funnel 19 for feeding flour 2 into a horizontally arranged screw conveyor 17.

By means of the horizontal screw conveyor 17, she flour 2 is conveyed into the vertically arranged screw conveyor 16. The vertical screw conveyor 16 has a drive 20 for setting a screw 21 of the vertical screw conveyor 16 in rotation, preferably at rotational speeds in the range of 100 rpm to 1500 rpm. The screw 21 has screw flights 22 for conveying the flour 2 to an inlet 12 of a tubular treatment chamber 4. A treatment zone 9, described in more detail, below, is arranged in the treatment chamber 4. At the end of the vertical screw conveyor 16 racing toward the treatment zone 9, the two lowermost screw flights 22 have a shortened design, such that a diameter of the screw 21 becomes smaller toward the treatment zone 9. In this way, the flour 2 trickles out of the screw 21 in the conically tapering area, as a result of which a curtain 10 is formed in the treatment zone 9. Moreover, at the end of the screw 21 facing toward the treatment zone 9, a conically widening distributor 23 is arranged for forming the curtain 10 in the treatment zone 9. In this way, the curtain 10 in the treatment zone 9 acquires a thickness d of approximately 8-10 mm. The distributor 23 has a width b of 50 mm on the side facing toward the treatment zone 9.

Upstream of a liquid feeding device 7, the apparatus 1 has an air delivery opening 15 as air delivery device.

In the treatment zone 9, parallel to a treatment zone axis 6, the curtain 10 has a length which is greater by about a factor of 50 than the thickness d. The curtain 10 has a tubular configuration.

Arranged in the treatment chamber 4 with the inner wall 5 is a nozzle ring, of which two nozzles 8 are shown. The two nozzles 8 are oriented toward the treatment zone axis 6 arranged parallel to the bulk material conveying direction F. The water 3 is directed to the curtain 10 at an angle α in the range of 30° to 70° in relation to the bulk material conveying direction F. The two nozzles 8 are arranged lying opposite each other in the circumferential direction. For greater clarity, no further nozzles are shown here.

By means of the nozzles 8, water 3 can be sprayed onto the curtain of flour 2 fed into the treatment zone 9 in the treatment chamber 4, in order to substantially wet the curtain 10 at least on the outer surface 33. By means of the liquid feeding device 7 comprising a pump, the water 3 is conveyed to the nozzles 8 at a pressure of 15 bar and sprayed onto the flour 2. By means of a conditioning device arranged in the liquid feeding device 7, the temperature of the water 3 is adjusted to a temperature of approximately 28° C.

By spraying the conditioned water 3 in the treatment zone 9 onto the curtain of flour 2 in the treatment chamber 4, a wetting of the flour 2 is effected by the conditioned water 3, such that a dough product 14 is produced. The dough product 14 can be a sourdough, for example.

Downstream from the treatment chamber 4, the dough product 14 is conveyed, through an outlet 13 of the treatment, chamber 4 into a maturing container 23 in which the dough product 14 is stored until it has the desired baking properties. For storage, the maturing container 25 has a bottom 29 on which some of the dough product 14 lies during storage. By means of a circulating device 26 in the form of a stirrer arranged in the maturing container 25, the dough product 14 is circulated during storage and also while being conveyed into the maturing container 25. An air discharge opening 11 is arranged as air discharge device between the maturing container 25 and the treatment chamber 4, such that the air conveyed by the water 3 is reliably conveyed out of the apparatus 1, and substantially no dough product 14 is conveyed upstream of the treatment zone 9.

Once the production of the dough, product 14 has been completed, water 3 can be sprayed, without the presence of the flour 2, into the treatment chamber 4 by means or the nozzles 8 for the purpose of cleaning the treatment chamber 4 and the downstream components of the apparatus 1. In this way, it is possible to carry out cleaning without disassembling the components of the apparatus 1, that is to say cleaning in place (CIP). As an alternative to this, one or more additional CIP nozzles (not shown in the drawings) could be present or could be introduced.

FIG. 2 shows a schematic view of an alternative apparatus according to the invention for producing a dough product 14, with a propeller 18 for generating the curtain 10.

Identical reference signs designate identical features in all the figures and are therefore explained again only when necessary.

As has already been shown in FIG. 1, the flour 2 is conveyed by means of the horizontal screw conveyor 17. Instead of a vertically arranged screw conveyor as a device for uniformly feeding the bulk material, the apparatus 1 according to FIG. 2 comprises a tube 31 for conveying the flour 2 from an outlet, of the horizontally arranged screw conveyor 17 to an inlet 12 of the treatment chamber 4.

By means of the propeller 18 which is arranged in the tube 31, and which can be set in rotation by the drive 20, the curtain 10 with the thickness d is formed and is conveyed along the tube 31 to the treatment chamber 4 by gravity. Uniform feeding of the bulk material is achieved in this way.

In the treatment chamber 4, the nozzles 8 are arranged spaced apart from each other and opposite each other in the circumferential direction. The two nozzles 8 are oriented toward the treatment zone axis 6 arranged parallel to the bulk material conveying direction F.

After the flour 2 has been wetted in the treatment zone 9, the dough product 14 is conveyed through an outlet 13 of the treatment chamber 4 into the maturing container 25.

FIG. 3 shows a schematic view of a distribution device 24 of an apparatus according to the invention.

The dough product 14, for example from an apparatus as shown in FIG. 1, is conveyed from the outlet of the treatment chamber 4 according to FIG. 1 into the distribution device 24 as far as the pump device 27. The pump device 27 is a pump that can be cleaned without disassembly. Pump devices 27 of this hind, with which viscous dough products can also be conveyed, are known to a person skilled in the art.

By means of the pump device 27, the dough product 14 is conveyed through the pipe system 28 to the maturing container 25. The maturing container 25 has a bottom 29 with a bottom opening 32 through which the dough product 14 can be conveyed into the maturing container 25. The bottom opening 32 can be closed by a valve 59, by means of which the flow info the maturing container 25 and/or the flow out of the maturing container can be controlled. In FIG. 3, the valve 59 is shown in a closure position. In this closure position, the dough product 14 located in the maturing container 25 can be circulated by means of the circulating device 26. Fermentation can take place which, for example in the case of sourdough, can last for a period of 3 hours to 24 hours.

By conveying the dough product 14 into the maturing container 25 through the bottom opening 32, it is possible to largely avoid the deposition of dough residues on driving parts of the circulating device 26.

FIG. 4 shows a schematic view of an alternative distribution device 24 of an apparatus according to the invention. In contrast to the distribution device according to FIG. 3, the distribution device 24 according to FIG. 4 has two maturing containers 25 into which the dough product 14 can be conveyed, by means of the pump device 27.

In the pipe system 28, two sliders 30 are arranged for selecting into which of the maturing containers 25 the dough product 14 is conveyed through the bottom openings 32.

In the examples according to FIGS. 3 and 4, the mixture can again leave the maturing containers 25 through the same bottom openings 32. As an alternative to this, it is also possible that the maturing containers 25 have separate openings, in particular separate bottom openings, through which mixture can again leave the maturing containers 25.

FIG. 5 shows a schematic plan view of an apparatus according to the invention, in the conveying direction of the bulk, material, with a treatment zone 9 of rectangular cross section and with a fiat curtain 10. A flat curtain 10 of this kind can be fed into the treatment zone 9 using a vibrating trough as the bulk material deciding device. In the treatment zone 9, flat nozzles 8 are arranged lying opposite each other for substantially complete wetting of the curtain 10 with water 3, at least, on the outer surface 33 of the curtain 10.

FIG. 6 shows a schematic plan view of an alternative apparatus according to the invention, in the conveying direction of the bulk material, with a tubular treatment zone 9 and with a circular curtain 10. A ring of ten nozzles 8 is arranged in the treatment zone 9 for substantially complete wetting of the curtain 10 with water 3, at least on the outer surface 33 of the curtain 10.

FIG. 7 shows a further apparatus 1 according to the invention which is suitable in particular for use in brewing. Coarsely ground malted barley is fed from a container 34 through a steam-tight and acid-resistant valve 35 into a treatment chamber 36. There, a conically widening distributor 27 is arranged which forms a curtain (not shown, here) from, the barley malt. With the aid of a pump 38 of a liquid feeding device 57, water is sprayed radially onto the curtain at a pressure of 10 bar for example, which leads to a continuous wetting of the barley malt. By means of an optional further pump 39, more water can be directed at the curtain. A pump device 40 leads the resulting mixture through a bottom opening 42 into a mash tun 41, in which a circulating device 43 is arranged in the form of a stirrer known per se.

An alternative embodiment is shown in FIG. 8. Here, coarsely ground malted barley is made available in a container 44, from which it is ted into a treatment chamber 47 by way of, for example, a horizontally arranged screw conveyor 45 and a steam-tight arid acid-resistant valve 46. In view of the fact that the raw material for the brewing is relatively coarse-grained in this example, it is possible to do without a vertically arranged screw conveyor. Instead, the treatment chamber 47 in this example contains only a conical distributor 48, which serves to generate a curtain from, the malted barley. A pump 49 of a liquid feeding device 58 ensures that water is sprayed onto this curtain, with a pressure of 10 bar, for example, being applied. The malt wetted in this way is then conveyed through an upper opening 50 into the mash tun 41.

Of course, it is also possible for the two embodiments according to FIGS. 7 and 8 to be combined with each other, i.e. with mash in accordance with FIG. 7 being conveyed through a bottom opening 42, and mash in accordance with FIG. 8 being conveyed through an upper opening 50, into one and the same mash tun 41.

In the embodiment shown in FIG. 9, coarsely grained malted barley is ted through a transport system 51, e.g. a screw conveyor, into a treatment chamber 52. A curtain of malted barley is generated in the treatment chamber 52. This can be done, for example, with the aid of a screw conveyor 21, shown in FIG. 9, which has a conical shape in the lower area. Alternatively or in addition, a curtain can be generated by a distributor of the kind described above but not shown in FIG. 9. Hot water is fed into the treatment chamber 52 through a further pipe 55 (preferably at a temperature in the range of 30° C. to 90° C.), where it is sprayed and directed, onto the curtain in order to wet the latter. By means of a pump device 54, the resulting mixture is conveyed through an ascending pipe 55 into a mash tun 56, of which only part, is shown here.

1-14. (canceled)

15. An apparatus for continuously wetting and/or mixing bulk material with a liquid, in order to produce a mixture,
wherein the apparatus comprises a bulk material feeding device for feeding the bulk material into a treatment zone,
a liquid feeding device for directly applying the liquid to the bulk material in the treatment zone,
the bulk material is feedable into the treatment zone as a curtain by the bulk material feeding device,
the liquid is applicable to the curtain substantially completely, at least on an outer surface of the curtain, by the liquid feeding device, and
the bulk material feeding device is designed as a device for uniformly feeding the bulk material into the treatment zone.

16. The apparatus as claimed in claim 15, wherein the bulk material feeding device and the liquid feeding device are arranged, in relation to each other, in such a way that the liquid is applied to the bulk material in the treatment zone substantially without contact with an inner wall of the apparatus.

17. The apparatus as claimed in claim 15, wherein the liquid is sprayable, by the liquid feeding device, onto the bulk material at a pressure in a range of 2 bar to 28 bar.

18. The apparatus as claimed in claim 15, wherein the liquid feeding device comprises at least two nozzles for directly applying the liquid to the bulk material in the treatment zone, and the at least two nozzles are arranged in such a way that the liquid is conveyed and directed to the curtain in a direction of the bulk material conveying direction.

19. The apparatus as claimed in claim 15, wherein an air discharge device is arranged downstream of the liquid feeding device.

20. The apparatus as claimed in claim 19, wherein the air discharge device is arranged between at least two nozzles of the liquid feeding device and a downstream conveying device and/or receiving device for the mixture.

21. The apparatus as claimed in claim 16, wherein the liquid feeding device comprises at least two nozzles for directly applying the liquid to the bulk material in the treatment zone, wherein the at least two nozzles are oriented toward the treatment zone axis arranged substantially parallel to a bulk material conveying direction.

22. The apparatus as claimed in claim 15, wherein the liquid feeding device comprises a conditioning device for adjusting a temperature of the liquid and/or for metering at least one additional substance into the liquid.

23. The apparatus as claimed in claim 15, wherein the bulk material feeding device comprises a substantially vertically arranged screw conveyor for conveying the bulk material into the treatment zone.

24. The apparatus as claimed in claim 23, wherein a diameter of a screw of the screw conveyor, on the side facing toward the treatment zone, is smaller than a diameter on the side facing away from the treatment zone.

25. The apparatus as claimed in claim 24, wherein an area of decreasing diameter extends over at least two screw flights.

26. The apparatus as claimed in claim 15, wherein a distributor is arranged between the bulk material feeding device and the treatment zone.

27. The apparatus as claimed in claim 28, wherein the distributor widens conically in a direction of the treatment zone.

28. The apparatus as claimed in claim 15, further containing a distribution device for distributing the mixture, wherein the distribution device comprises at least one maturing container, and a circulating device is arranged in the at least one maturing container for the purpose of circulating the mixture, the distribution device comprises a pump device and a pipe system for distributing the mixture into the at least one maturing container, the pipe system is in fluidic communication with a bottom of the at least one maturing container for conveying the mixture into the at least one maturing container.

29. The apparatus as claimed in claim 28, the distribution device comprising at least two maturing containers.

30. The apparatus as claimed in claim 29, wherein the distribution device comprises at least one fixture by which it is controllable and/or regulatable into which of the maturing containers the mixture is conveyed.

31. The apparatus as claimed in claim 28, wherein the maturing container has at least one opening through which the mixture can flow into and/or out of the maturing container, and the maturing container moreover contains at least one valve by which the inward and/or outward flow is controllable.

32. A method for continuously wetting and/or mixing bulk material with a liquid in an apparatus, wherein the apparatus comprises a treatment zone, a bulk material feeding device for feeding bulk material into the treatment zone, and a liquid feeding device for directly applying the liquid to the bulk material in the treatment zone,
the method comprising the steps of”:
feeding the bulk material into the treatment zone as a curtain,
then applying the liquid to the curtain substantially completely at least on the outer surface in order to produce a mixture, and
feeding the bulk material uniformly into the treatment zone.

33. The use of the apparatus as claimed in claim 15 in brewing.
